(19) United States
(12) Patent Application Publication
(10) Pub. No.: US 2004/0013600 A1
(43) Pub. Date: Jan. 22, 2004

(54) Intellectual message energetic water

(76) Inventors: Jian-Ming Lai, Miaulee (TW); Ching-Siu Yang, Taiwan (TW)

Correspondence Address: Jan-Ming Lai, 235 Chung-Ho Box 8-24, Taipei, TW

(21) Appl. No.: 10/195,185

(22) Filed: Jul. 16, 2002

(51) Int. Cl. C01B 5/00

(52) U.S. Cl. 423/580.1

(57) ABSTRACT

Intellectual message energetic water, wherein water is processed by an energy message recorder so that different messages are inputted into water to generate high efficiency message energetic water, and correct message wave is generated for correcting fault messages into normal message; the high efficiency message energetic water is used as drinking water, breeding animal, cultivating plants, industrial products, environment improvement, foods, sanitary products, medical products, drugs and cosmetics.

### BACKGROUND OF THE INVENTION

1. Field of the Invention

The present invention relates to intellectual message energetic water, wherein water is processed by an energy message recorder so that different messages are inputted into the water to generate high efficiency message energetic water, and correct message wave is generated for correcting fault messages into normal message; the high efficiency message energetic water is used as drinking water, breeding animal, cultivating plants, industrial products, environment improvement, foods, sanitary products, medical products, drugs and cosmetics.

2. Description of Related Art

In general, energetic water is radiated by far infrared so to form micro water molecules. Then the water is ionized as negative ion or π water as illustrated in FIGS. 1-1 and 1-2.

However, water from above said method can not have a predetermined frequency to be locked since the energy level is too larger to clearly show the difference of different levels and thus the content can not be recorded.

In general, the water can not record message of an object and timing.

### SUMMARY OF THE INVENTION

Accordingly, the primary object of the present invention is to provide intellectual message energetic water, wherein water is processed by an energy message recorder so that different messages are inputted into the water to generate high efficiency message energetic water, and correct message wave is generated for correcting fault messages into normal message; the high efficiency message energetic water is used as drinking water, breeding animal, cultivating plants, industrial products, environment improvement, foods, sanitary products, medical products, drugs and cosmetics.

The various objects and advantages of the present invention will be more readily understood from the following detailed description when read in conjunction with the appended drawing.

### BRIEF DESCRIPTION OF THE DRAWINGS

FIG. 1 shows that a plurality of messages are recorded to the message energetic water of the present invention.

FIG. 1-1 shows the first manufacturing block diagram of the general energetic water.

FIG. 1-2 shows the second manufacturing block diagram of the general energetic water.

FIG. 2-1 shows the manufacturing block diagram of the message energetic water of the present invention.

FIG. 2-2 is a block diagram for describing FIG. 2-1.

FIG. 3 shows the message of the message energetic water of the present invention.

FIG. 4 shows the error message.

FIG. 5 shows the correct wave from the message oscillation of the message energy water and error message according to the present invention.

### DETAILED DESCRIPTION OF THE PREFERRED EMBODIMENTS

The present invention discloses an intellectual message energetic water. The “message energy” is such as instructions in a computer. A great variety of cipher messages are existed in the human body, which is related to the thought, motions, mechanism, fate, etc.

Water, H₂O, is formed by two hydrogen atoms and one oxygen atoms. The two hydrogen atoms are positive and oxygen is negative, and thus the hydrogen and oxygen are magnetically connected and water is neutral. Since the hydrogen is positive in the water and oxygen is negative in the water, they can work as the magnetic powders in a disk so that they can record message.

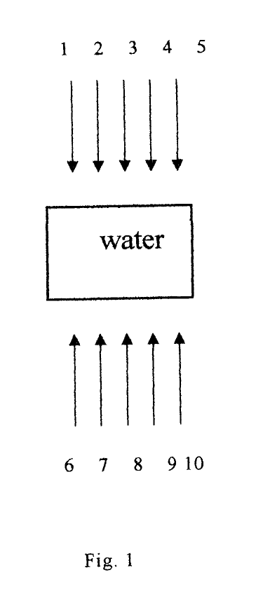

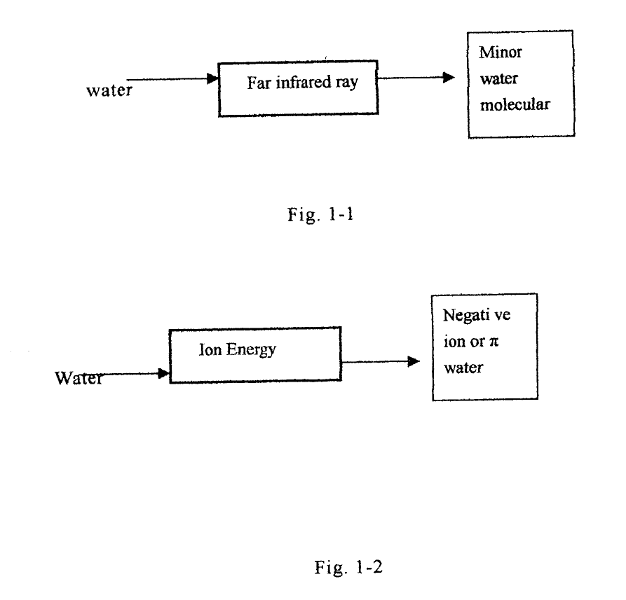

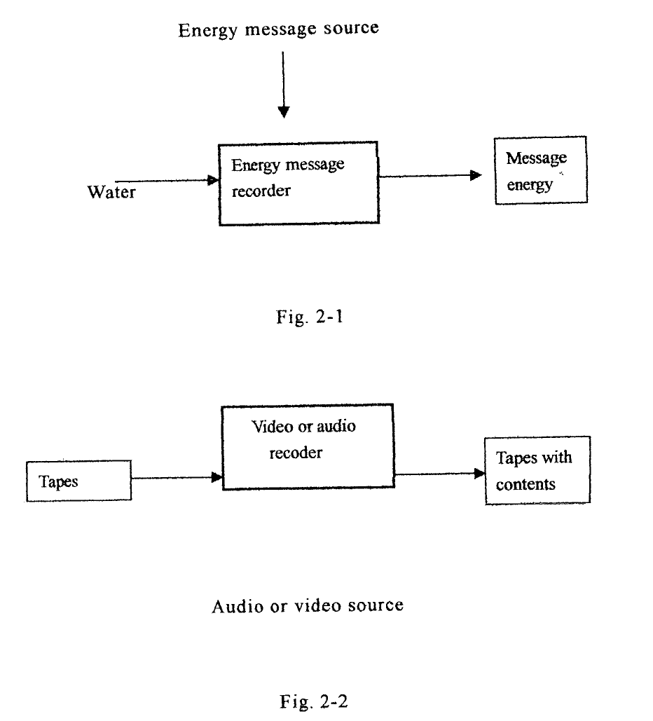

Thereby, many messages (1, 2, 3, 4, 5, 6, 7, 8, 9, 10), see FIG. 1, can be recorded by the magnetic variations of the water by external effects. Referring to FIG. 2-1 and FIG. 2-2, water is recorded with messages through an energy message reader like a video or audio tapes. Thereby, message energetic water can record messages precisely according to a required frequency. The messages in the water are time independent and can search disadvantageous messages in the human body (negative waveforms) so as to generate energy messages to cause the energy of the water to become positive message energy with a preferred condition. Thereby, a vibration occurs so that the water has the effect of automatic correct human energy.

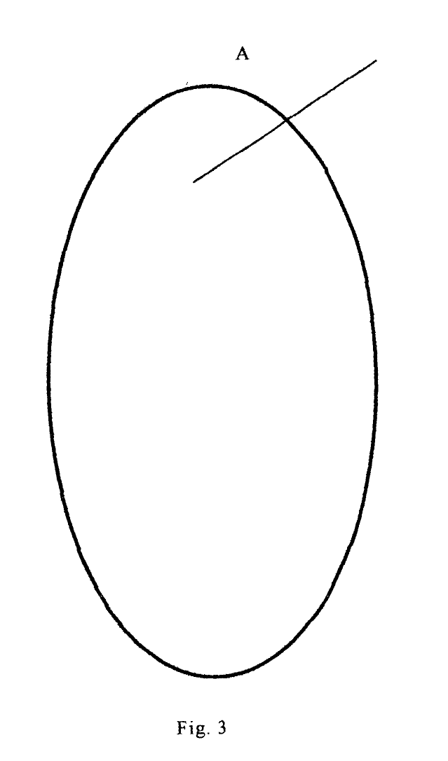

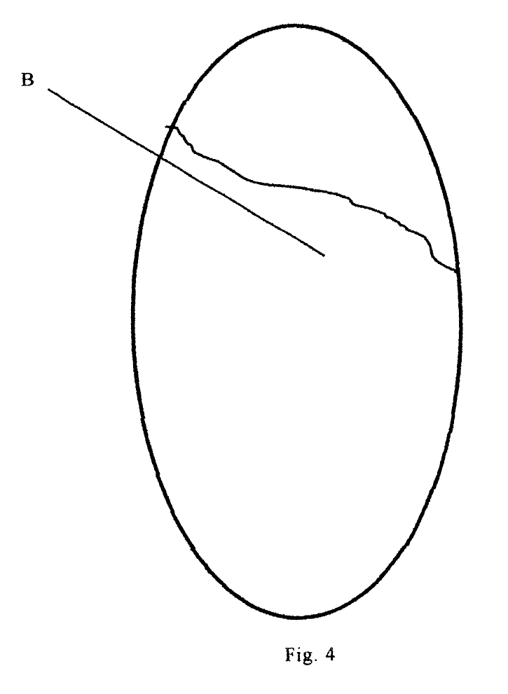

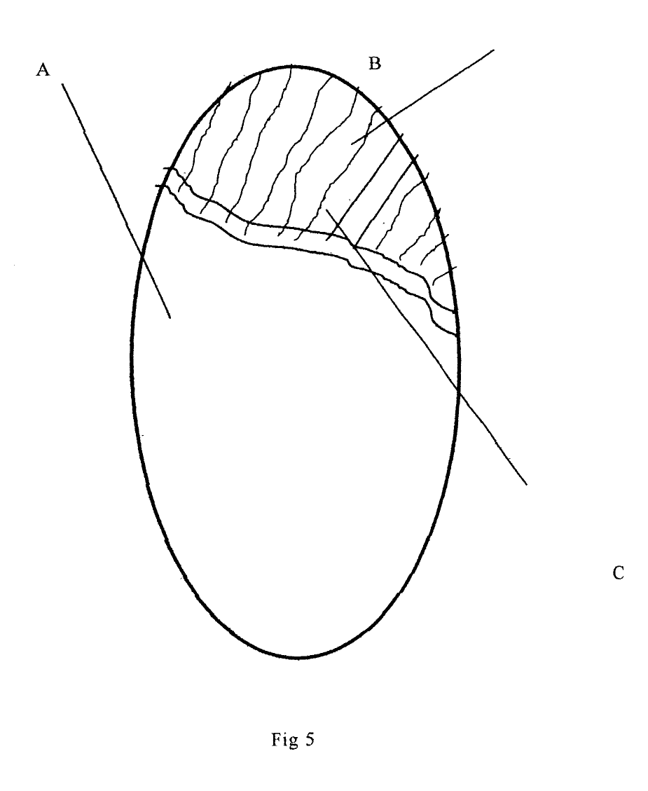

With reference to FIG. 5, the correct wave generated by the oscillation from the message energetic water of the present invention and fault messages. A positive ellipse represents a normal message, see FIG. 3. Referring to FIG. 4, B represents a fault message. FIG. 5 shows that the oscillation of the intellectual message energetic water generates a C correct wave. The correct water C corrects the fault portion in the fault message B so that the fault message B recovers to normal message A. In the following, one example will be described in the following, in that, intellectual message energetic water in the human body is compared with some testing objects and a Quantum Resonance Spectrometer (QRS) is used to measure the wave of water.

Embodiment 1:

A 42 year's old man drink the intellectual message energetic water, a quantum resonance spectrometer is used to measure the result as the following:

| | | | 200 cc | | ®cc |
|---|---|---|---|---|---|
| | | | intel- | 200 cc | Drink |
| | Wave | 200 cc | lectual | Drink | intellectual |
| | vibration | Mes- | message | message | message |
| | in human | sage | energetic | energetic | energetic |
| Test items: | body | water | water | water | water |
| Brain | +64 | over | 0 | +840 | +4460 |
| function | | 10000 | | | |
| Lung | −46 | over | 0 | +440 | +1640 |
| function | | 10000 | | | |
| Heart | +86 | over | 0 | +760 | +3440 |
| function | | 10000 | | | |
| Liver | −86 | over | 0 | +440 | +1640 |
| function | | 10000 | | | |
| Gall | +86 | over | 0 | +790 | +1540 |
| function | | 10000 | | | |
| Kidney | −440 | over | 0 | +44 | +460 |
| function | | 10000 | | | |
| Spleen | +64 | over | 0 | +740 | +1660 |
| function | | 10000 | | | |
| Pancreas | +46 | over | 0 | +560 | +1340 |
| | | 10000 | | | |
| Stomach | +44 | over | 0 | +470 | +1080 |
| function | | 10000 | | | |
| High blood | +46 | over | 0 +490 | +1040 | |
| pressure | | 10000 | | | |
| Diabetes | +44 | over | 0 | +490 | +1240 |
| | | 10000 | | | |
| Metabolism | −74 | over | 0 | +440 | +1040 |
| | | 10000 | | | |
| Iimmuniza- | +444 | over | 0 | +1460 | +4840 |
| tion | | 10000 | | | |
| Malignant | +98 | over | 0 | +440 | +860 |
| tumor | | 10000 | | | |
| Blood | −440 | over | 0 | +86 | +470 |
| circulation | | 10000 | | | |
| Arterioscle- | +8 | over | 0 | +340 | +960 |
| rosis | | 10000 | | | |
| Tumor | −6 | over | 0 | +94 | +640 |
| | | 10000 | | | |
| Osteopor- | +44 | over | 0 | +840 | +2460 |
| osis | | 10000 | | | |
| Thrombus | +49 | over | 0 | +940 | +3440 |
| | | 10000 | | | |
| Self- | −88 | over | 0 | +86 | +660 |
| control | | 10000 | | | |
| nerves | | | | | |
| | A’ | B’ | C’ | D’ | E’ |

Note:
A’: Wave vibration of one to be tested.
B’: The wave (not used) of the message energetic water (with high energy value).
C’: Intellectual message energetic water.
D’: The one to be tested drinks message energetic water.
E’: The one to be tested drinks intellectual message energetic water.

From above result, it is known that intellectual message energetic water E has a value larger than that of the message energetic water D. That is, the intellectual message energetic water of the present invention is more helpful to the user.

Embodiment 2:

A 40 year's old woman drink the intellectual message energetic water, a quantum resonance spectrometer is used to measure the result as the following:

| | | | 200cc | | 200cc |
|---|---|---|---|---|---|
| | | | intel | 200 cc | Drink |
| | Wave | 200 cc | lectual | Drink | intellectual |
| | vibration | Mes | message | message | message |
| | in human | sage | energetic | energetic | energetic |
| Test items: | body | water | water | water | water |
| Brain | +44 | over | 0 | +880 | +1480 |
| function | | 10000 | | | |
| Lung | +88 | over | 0 | +1440 | +1760 |
| function | | 10000 | | | |
| Heart | +44 | over | 0 | +860 | +1440 |
| function | | 10000 | | | |
| Liver | −6 | over | 0 | +68 | +86 |
| function | | 10000 | | | |
| Gall | +66 | over | 0 | +880 | +1850 |
| function | | 10000 | | | |
| Kidney | −6 | over | 0 | +96 | +145 |
| function | | 10000 | | | |
| Spleen | +86 | over | 0 | +1840 | +2940 |
| function | | 10000 | | | |
| Pancreas | +44 | over | 0 | +990 | +1440 |
| | | 10000 | | | |
| Stomach | −88 | over | 0 | +68 | +164 |
| function | | 10000 | | | |
| High blood | +40 | over | 0 | +880 | +1480 |
| pressure | | 10000 | | | |
| Diabetes | +66 | over | 0 | +680 | +940 |
| | | 10000 | | | |
| Metabolism | −84 | over | 0 | +66 | +97 |
| | 10000 | | | | |
| Iimmuniza- | +1460 | over | 0 | +6660 | +9680 |
| tion | | 10000 | | | |
| Malignant | −4 | over | 0 | +88 | +440 |
| tumor | | 10000 | | | |
| Blood | −860 | over | 0 | +8 | +84 |
| circulation | | 10000 | | | |
| Arterioscle- | −4 | over | 0 | +98 | +240 |
| rosis | | 10000 | | | |
| Tumor | −9 | over | 0 | +78 | +170 |
| | | 10000 | | | |
| Osteoporo | −868 | over | 0 | +8 | +87 |
| sis | | 10000 | | | |
| Thrombus | +4 | over | 0 | +480 | +1040 |
| | | 10000 | | | |
| Self- | −1460 | over | 0 | +6 | +47 |
| control | | 10000 | | | |
| nerves | | | | | |
| | A’ | B’ | C’ | D’ | B’ |

Note:
A’: Wave vibration of one to be tested.
B’: The wave (not used) of the message energetic water (with high energy value).
C’: Intellectual message energetic water.
D’: The one to be tested uses message energetic water.
B’: The one to be tested uses intellectual message energetic water.

From above result, it is known that intellectual message energetic water E has a value larger than that of the message energetic water D. That is, the intellectual message energetic water of the present invention is more helpful to the user.

Embodiment 3:

A 48 yearns old man drink the intellectual message energetic water, a quantum resonance spectrometer is used to measure the result as the following:

| | | | 200 cc | | 200 cc |
|---|---|---|---|---|---|
| | | | intel- | 200 cc | Drink |
| | Wave | 200 cc | lectual | Drink | intellectual |
| | vibration | Mes- | message | message | message |
| | in human | sage | energetic | energetic | energetic |
| Test items: | body | water | water | water | water |
| Brain | −860 | over | 0 | +64 | +640 |
| function | | 10000 | | | |
| Lung | +4 | over | 0 | +1440 | +4460 |
| function | | 10000 | | | |
| Heart | +8 | over | 0 | +1660 | +5460 |
| function | | 10000 | | | |
| Liver | −440 | over | 0 | +64 | +480 |
| function | | 10000 | | | |
| Gall | +14 | over | 0 | +2440 | +6740 |
| function | | 10000 | | | |
| Kidney | −860 | over | 0 | +46 | +640 |
| function | | 10000 | | | |
| Spleen | −84 | over | 0 | +440 | +4440 |
| function | | 10000 | | | |
| Pancreas | −68 | over | 0 | +480 | +4480 |
| | | 10000 | | | |
| Stomach | −460 | over | 0 | +84 | +440 |
| function | | 10000 | | | |
| High blood | +4 | over | 0 | +840 | +3440 |
| pressure | | 10000 | | | |
| Diabetes | +4 | over | 0 | +640 | +2460 |
| | | 10000 | | | |
| Metabolism | −4480 | over | 0 | −66 | +94 |
| | | 10000 | | | |
| Iimmuniza- | +14 | over | 0 | +860 | +2980 |
| tion | | 10000 | | | |
| Malignant | −29 | over | 0 | +86 +440 | |
| tumor | | 10000 | | | |
| Blood | −9460 | over | 0 | −460 | +4 |
| circulation | | 10000 | | | |
| Arterioscle | +6 | over | 0 | +860 | +4440 |
| rosis | | 10000 | | | |
| Tumor | −44 | over | 0 | +84 | +340 |
| | | 10000 | | | |
| Osteoporo- | −4860 | over | 0 | −66 | +44 |
| sis | | 10000 | | | |
| Thrombus | +6 | over | 0 | +660 | +4640 |
| | | 10000 | | | |
| Self- | −66 | over | 0 | +340 | +2460 |
| control | | 10000 | | | |
| nerves | | | | | |
| | A’ | B’ | C’ | D’ | E’ |

Note:
A’: Wave vibration of one to be tested.
B’: The wave (not used) of the message energetic water (with high energy value).
C’: Intellectual message energetic water.
D’: The one to be tested uses message energetic water.
E’: The one to be tested uses intellectual message energetic water.

From above result, it is known that intellectual message energetic water E has a value larger than that of the message energetic water D. That is, the intellectual message energetic water of the present invention is more helpful to the user.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. Intellectual message energetic water, wherein water is processed by an energy message recorder so that different messages are inputted into the water to generate high efficiency message energetic water, and correct message wave is generated for correcting fault messages into normal message; the high efficiency message energetic water is used as drinking water, breeding animal, cultivating plants, industrial products, environment improvement, foods, sanitary products, medical products, drugs and cosmetics.

2. The intellectual message energetic water as claim in claim 1, wherein the intellectual message energetic water will oscillate to generate message wave.

3. The intellectual message energetic water as claim in claim 1, wherein the correct message wave corrects error part so as to correct error messages into normal messages.

4. The intellectual message energetic water as claim in claim 1, wherein the high efficiency message energetic water is called as intellectual message energetic water.

5. The intellectual message energetic water as claim in claim 1, wherein a quantum resonance spectrometer is used to measure human body, the higher the measured value, the better the health of the human body.

6. The intellectual message energetic water as claim in claim 1, wherein a quantum resonance spectrometer is used to measure human body, the lower the measured value, the worse the health of the human body.
